(19) United States
(12) Patent Application Publication
(10) Pub. No.: US 2008/0174405 A1
(43) Pub. Date: Jul. 24, 2008

(54) SYSTEM, DEVICE AND METHOD FOR CONTROLLING A MOBILE DEVICE

(76) Inventor: Fredrik TOORN, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/625,865

(22) Filed: Jan. 23, 2007

(51) Int. Cl. H04Q 1/00

(52) U.S. Cl. 340/10.1

(57) ABSTRACT

The present invention relates to the field of mobile communications, and in particular to a system for wireless data communication for steering/controlling the functionality of a mobile device comprising a radio communication device and a method for achieving this.

### TECHNICAL FIELD OF THE INVENTION

The present invention relates to the field of mobile communications, and in particular to a system for wireless data communication for steering/controlling the functionality of a mobile device comprising a radio communication device and a method for achieving this.

### DESCRIPTION OF RELATED ART

Today, the use of mobile devices, e.g. cellular/mobile phones, laptop computers and Personal Digital Assistants (PDA:s), that communicate wireless increases. This means that users bring the mobile devices with them wherever they go, e.g. to the office and back home, into their car, to meetings, and so on. This behaviour has given raise to problems of disturbing the surrounding, e.g. when users forget to switch their mobile device off or into silent mode when entering a meeting room or a cinema and disturbing calls or alarms occur, and/or forget to change the current mobile device setting/profile so that all calls are forwarded to their office phone when in the office, or to a voice mail if the user is busy in a meeting, or that the mobile device user forget to switch the device into a handsfree “car” mode when the user enter his/her car, the latter problem also reduces safety when driving.

There is also a need of receiving for example special offers from shops or restaurants when passing these establishments, and also to receive streamed data, e.g. movies of a football/soccer/hockey match when watching it live in an arena or to see the match from other angles or replays of goals. In the future, advertisements or traffic information may also be sent wirelessly locally to these mobile devices.

Prior art uses for example the GPS system for tracking mobile devices and depending on where they are sends information about nearby restaurants, shops, and events, but this technology is complicated. There are also Bluetooth devices available that can send the actual data to the mobile device when you get in range, but they are more complex and expensive. The drawback with both GPS and Bluetooth is also that they consume much power, i.e. a GPS in a phone consume much power and an external Bluetooth device needs power to work.

### SUMMARY

The present invention relates to a system, a device and a method using RFID to wirelessly control/steer the functionality for a mobile device, both automatically and/or manually, i.e. by manual initiation from the user when prompted for this. This reduces the risk of forgetting to switch the mobile device into desired mode when necessary.

The invention uses a system for RFID data communication, comprising a mobile device with a control unit that is operatively connected to a RFID reader, a memory for storing a plurality of RFID tag data, and a GSM/UMTS radio; and at least one by the mobile device wirelessly connectable RFID tag, which control unit, depending on the RFID tag data, is adapted to change or maintain the functionality of the mobile device.

In one embodiment of the invention the control unit is configured to compare the received RFID tag data with RFID tag data stored in the memory, and to change or maintain the functionality of the mobile device in accordance with the received RFID tag data. In another embodiment of the invention, if the received RFID tag data is new when compared with the stored RFID tag data, the control unit is configured to register the received RFID tag data in the memory, and to associate the received RFID tag data with an activation application, which changes the current functionality of the mobile device, or a non-activation application, which maintains the current functionality of the mobile device, and to store the received RFID tag data with the associated application in the memory.

In yet another embodiment of the invention the control unit is configured to detect if the RFID tag is out of range, and to compare the data of the out of range RFID tag with the stored RFID tag data, and to perform an activity that changes or maintains the current functionality of the mobile device in accordance with the data of the out of range RFID tag.

In still another embodiment the control unit is configured to enable, disable or maintain a silent mode, a forwarding calls mode, an AGPS functionality mode or a data streaming mode for the mobile device in accordance with the associated RFID tag data. The forwarding calls mode in one embodiment is realized in that the control unit is configured to enable, disable or maintain a mobile device mode where all calls are forwarded to a voice mail or an office phone in accordance with the associated RFID tag data.

Moreover, the invention uses a mobile phone, comprising a control unit that is operatively connected to a RFID reader, a memory, a display, and a GSM/UMTS radio. Furthermore, the invention also uses a radio communication device for RFID data communication, comprising a RFID reader that is operatively connected to a mobile device.

The invention also uses a method for steering the functionality of a mobile device by using RFID data communication, comprising transmitting a radio signal to a RFID tag, receiving a response signal comprising RFID tag data from the RFID tag, and, depending on the RFID tag data, performing an activity that changes or maintains the functionality of the mobile device. This is done in one embodiment by comparing the received RFID tag data with the stored RFID tag data, and, performing an activity that changes or maintains the functionality of the mobile device in accordance with the received RFID tag data. If the received RFID tag data is new when compared with the stored RFID tag data, i.e. not matched, another embodiment comprises registering the received RFID tag data, associating the received RFID tag data with an activation application changing the current functionality of the mobile device or a non-activation application maintaining the current functionality of the mobile device, and storing the received RFID tag data with the associated application.

Another method according to the invention comprises detecting that the RFID tag is out of range, comparing the data of the out of range RFID tag with the stored RFID tag data, and performing an activity that changes or maintains the functionality of the mobile device in accordance therewith. In yet another embodiment the method comprises enabling, disabling or maintaining a silent mode, forwarding calls mode, an assisted GPS (AGPS) functionality mode or a data streaming mode for the mobile device in accordance with the associated RFID tag data. Another embodiment of the method comprises performing an activity by putting the mobile device into a mode where all calls are forwarded to a voice mail or an office phone, or vice versa in accordance with the associated RFID tag data. Moreover, in another embodiment, the method comprises performing an activity by putting the mobile device into a mode where the AGPS functionality is enabled or disabled in accordance with the associated RFID tag data. Furthermore, another embodiment uses a method comprises performing an activity by putting the mobile device into a mode where streaming is started from an address distributed by the associated RFID tag, or vice versa in accordance with the associated RFID tag data.

The invention simplifies the usage and handling of the mobile device by providing both automatic and manual operation of the device. Moreover, the invention requires less power when communicating with RFID tags compared to the use of GPS in the mobile device. Furthermore, the invention achieves these advantages in a cheaper and more cost-efficient way by using RFID data communication due to the fact that RFID tags are cheap and easy to place in suitable positions and locations. Furthermore, RFID tags require less power to work, especially passive RFID tags that only use power from the communicating device, in comparison to Bluetooth units. This invention also eliminates the need of separate RFID readers or PDA:s, e.g. in hospitals and for surveillance/guarding systems and services in which watchmen detect/register that they have been at the required locations, whereby for example their mobile phones are used for this instead.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It should also be emphasised that the term “comprises/comprising” when used in this specification is taken to specify the presence of stated features, integers, steps or components but does not preclude the presence or addition of one or more other features, elements, integers, steps, components or groups thereof.

### BRIEF DESCRIPTION OF THE DRAWINGS

The features and advantages of the present invention will be more apparent from the following description of the invention with reference to the accompanying drawings, on which:

FIG. 1 schematically illustrates an embodiment according to the present invention comprising a wireless communications system and a mobile device;

FIG. 2 schematically illustrates a method according to an embodiment of the invention in a block diagram; and

FIGS. 3 to 5 schematically illustrate methods according to different embodiments of the invention in block diagrams.

### DETAILED DESCRIPTION OF EMBODIMENTS

Radio Frequency Identification, or RFID, is a generic term for technologies that use radio waves to automatically identify people or objects. There are several methods of identification, but the most common is to store a serial number that identifies a person or object, and/or other information, on a microchip that is attached to an antenna (the chip and the antenna together are called an RFID transponder or an RFID tag). The antenna enables the chip to transmit the identification information to a RFID reader. The reader converts the radio waves reflected/sent back from the RFID tag into digital information that can then be passed on to and for example used in computers. A typical RFID system consists of at least one RFID tag made up of a microchip with an antenna, and an RFID interrogator or reader with an antenna. The reader sends out electromagnetic waves and the tag antenna is tuned to receive these waves. The chip then modulates the waves that the tag sends back to the reader, which converts the new waves into digital data that are communicated to a control unit or processor for further processing or use.

RFID systems are for example used for tracking animals to triggering equipment down oil wells. The most common RFID applications are payment systems (toll and fare collection systems, for instance), access control and asset tracking. Increasingly, companies use RFID technology to track goods within their supply chain, to work in process and for other applications.

There are two types of RFID tags, active and passive. Active RFID tags have a transmitter and their own power source (typically a battery). The power source is used to run the microchip's circuitry and to send a signal to the RFID reader (similar to a cellular phone transmitting signals to a base station). Passive tags have no battery; instead, they draw power from the RFID reader, which sends out electromagnetic waves that induce a current in the RFID tag's antenna. Semi-passive tags use a battery to run the chip's circuitry, but communicate by drawing power from the reader. Active and semi-passive tags are useful for tracking high-value goods that need to be scanned over long ranges, such as railway cars on a track, but they cost more than passive tags, which means that they are not used on low-cost items.

The distance from which a tag can be read is called its read range. Read range depends on a number of factors, including the frequency of the radio waves used for tag-reader communication, the size of the tag antenna, the power output of the reader, and whether the tags have a battery to broadcast a signal or gather energy from a reader and merely reflect a weak signal back to the reader. If the tags are attached to products with water or metal, the read range can be significantly less. If the size of the UHF antenna on UHF tags—the kind used on pallets and cases of goods in the supply chain—is reduced, that will also dramatically reduce the read range. Increasing the power output could increase the range, but most governments restrict the output of readers so that they don't interfere with other RF devices, such as cordless phones.

RFID systems use many different frequencies, but generally the most common are low-frequency (around 125 KHz), high-frequency (13.56 MHz) and ultra-high-frequency or UHF (860-960 MHz). Microwave (2.45 GHz), e.g. as in Bluetooth, may also be used in some applications. Radio waves behave differently at different frequencies, whereby a suitable frequency has to be chosen for the application.

There are companies developing technology that could make active tags far less expensive than they are today. End-users are focusing on passive UHF tags, which cost less than active ones. Their read range isn't as far as active tags but can be disposed of with the product packaging without any great economic loss. RFID tags are cheap to manufacture and are more useful for applications where the tag will be disposed of with the product packaging.

In the present invention, any suitable radio frequency may be used, i.e. from low-frequency to microwave-frequency, however, the frequencies used for Bluetooth or WLAN (2.4 GHz) are probably preferred for wireless communication between the mobile device 100 and at least one RFID tag 150 in the vicinity due to a possibility or reusing the antenna for Bluetooth, whereby different frequencies determine different distances between the mobile device and the RFID tag for when the tag gets into and out of read range for the mobile device.

The present invention is described below with reference to block diagrams and/or flowchart illustrations of methods, systems, and devices according to embodiments of the invention. It is understood that several blocks of the block diagrams and/or flowchart illustrations, and combinations of blocks in the block diagrams and/or flowchart illustrations, can be implemented by computer program instructions used in the system and/or device. Accordingly, the present invention may be embodied in present hardware and software (including firmware, resident software, micro-code, etc.) or may be placed in a separate module incorporated in a mobile device for use or as an external accessory communicating through USB or another available communication bus.

The present invention relates to a RFID data communications system and a portable device, i.e. a portable radio communications device, also denoted as a mobile device. In the context of the invention, the mobile device may be a mobile/cellular phone, a PDA or any other type of portable computer, such as a laptop computer.

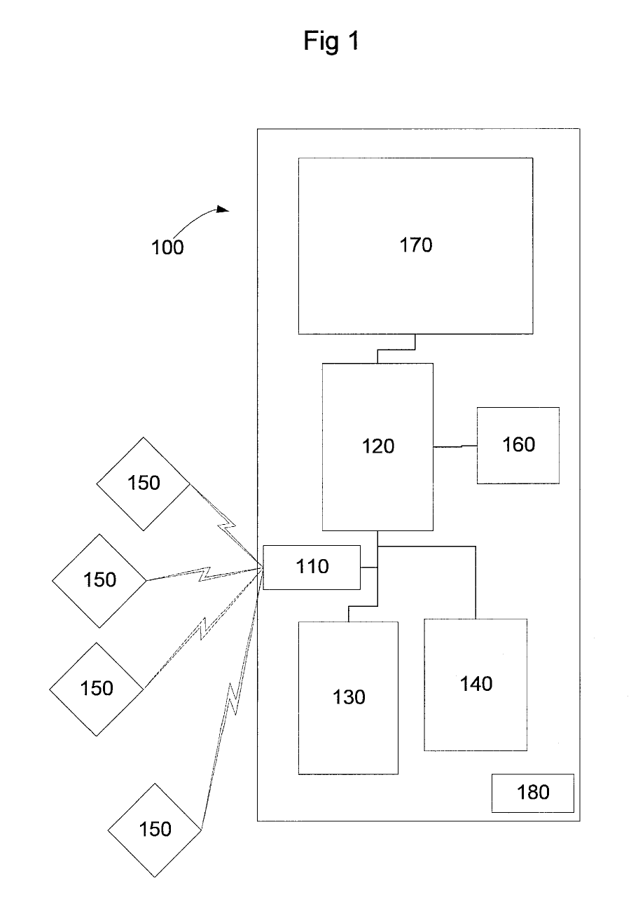

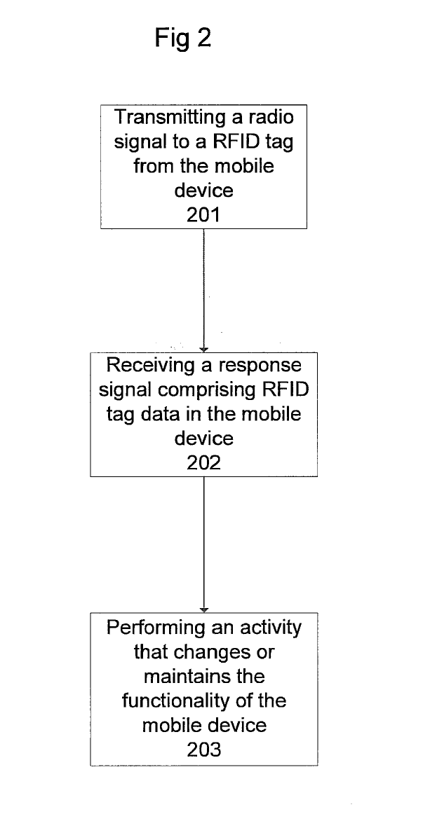

Referring to FIG. 1, a mobile device 100 is disclosed. The mobile device 100 comprises an antenna 110 which in one embodiment of the present invention is a combined GSM and RFID antenna or a UMTS and RFID antenna and in another embodiment the antenna is a separate RFID antenna 110. However, it should be understood that the mobile device 100 may be equipped with separated antennas such as a GPS antenna and a GSM antenna and a RFID antenna or just one type of combined antenna such as an UMTS, GSM, EDGE, GPRS, CSD, RFID antenna or the like. In any case, device 100 is configured, by means of antenna 110, to transmit wireless signals as in step 201 in FIG. 2 and receive wireless signals comprising data from any RFID tag 150 in the vicinity, as in step 202 of FIG. 2. The antenna 110 in the illustrated embodiment may be a solid external antenna but may as well be an extendable antenna or an internal antenna. Antenna 110 is connected to a control unit 120, which comprises a signal transceiver and also connected to a RFID reader, i.e. RFID radio unit 130, which is configured to receive wireless information including information/data from any nearby RFID tag within range, and a GSM/UMTS radio unit 140, which is configured to receive wireless information including information/data from a cellular network and/or a GPS system. The control unit 120 typically includes a central processing unit CPU with associated memory 160 and software, and is configured to control the processes carried out within the device 100. The signal transceiver is connected to control unit 120, inter alia for communication of data/information received by means of antenna 110. The information received in the device 100 is in the form of data which needs to be analyzed to determine if an activity is to be performed or not in response to the data received from the RFID tag 150 nearby, as will be explained. The control unit 120 is configured to perform measures to be taken for controlling, i.e. changing or maintaining the current functionality of the device 100 based on the information from the associated RFID tag 150 (see step 203 in FIG. 2). Alternatively, the information received from the RFID tag may be handled automatically without any interaction from the user of the mobile device 100, so that different functions/functionality in the mobile device is initiated fully automatic. The user may or may not choose manual initiation of a measure that either changes or maintains the current functionality of the device 100. In other embodiments of the invention, certain RFID tags/locations, e.g. hospitals and cinemas, would for example always change the current functionality of a mobile phone 100 by turning/setting it into silent mode or simply turn the phone off or perform other predefined scenarios or standardized functions.

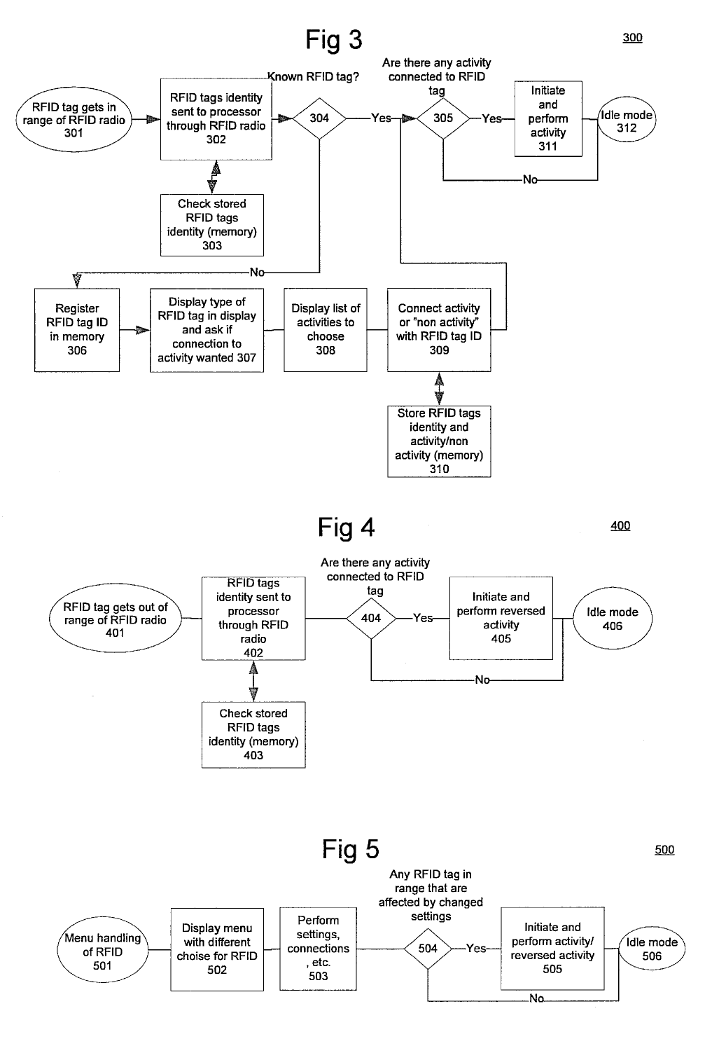

The steering/control of the current functionality in the mobile device 100 is done by using short-range positioning beacons, i.e. RFID tags 150 getting into range of the RFID radio/reader 130 and communicating with the RFID reader (step 301 in FIG. 3). This method is applicable in relatively small areas, depending on the used radio frequency for communication, such as a single building, but also along frequently visited roads, wherein a local area network of RFID systems can provide locations along with other services. For really short range applications within buildings, appropriately equipped RFID systems can use Bluetooth for short-range positioning and/or any other function that requires more data to be transferred from the present location, i.e. within range of the current RFID tag 150, into the mobile device 100. The position data in such systems will be more accurate than in a cellular positioning system, due to the shorter communication range and better indoor coverage.

The position of the mobile device 100 determined by means of the received information from the RFID tag 150 relating to a current position, and the application to be launched or not, are used in combination by control unit 120 to select a profile which is position-dependent, either automatically or manually by the user, and to load and execute the selected application using parameters determined in the selected profile (steps 301-312 in FIG. 3). The profiles may be manually programmed in advance by means of a graphical user interface (GUI) of mobile device 100, typically a keypad and a display 170 with a menu system. As an alternative, profiles may be stored according to usage. In one embodiment, a profile may be stored when a certain application is launched in accordance with certain RFID tag data for the first time in a certain position, which may or may not have been previously visited by the mobile device 100. In the illustrated embodiment of FIG. 1 the profiles are stored in the memory 160 which may be a random access memory (RAM), a read-only memory (ROM) and an erasable programmable read-only memory (EPROM or Flash memory). Each profile is stored in memory 160 together with one or more related settings for different applications, for use by the mobile device 100, i.e. the control unit 120 in order to steer the functionality of the mobile phone by using received data from one or more RFID tags in the wireless network, such as a low-frequency RFID system, high-frequency RFID system and ultra-high-frequency or UHF RFID system. An IEEE 802.11 type WLAN, a WiMAX, a HiperLAN, a Bluetooth LAN, or a cellular mobile communications network such as a GPRS network, or a third generation WCDMA network can then be used for providing a communication channel where more information could be downloaded based on the initial data provided by the RFID tag 150. The mobile device 100 in FIG. 1 is able to connect to different wireless networks through wireless interface units as mentioned above, e.g. by putting the mobile device 100 into a mode where streaming is started from an address distributed by the associated RFID tag 150, or vice versa, i.e. ongoing streaming is interrupted in accordance with the received RFID tag data. This function is only required for communication of larger amounts of data, if only a new setting/functionality of the mobile device 100 is to be enabled this does not require a large amount of data.

The mobile device 100 is configured to automatically use the relevant settings for an application in a certain position or to give the user choices of settings that may be manually chosen by him to use the RFID tag data within range or not. This way drainage of a battery 180 of the mobile device is reduced, since RFID communication consumes less power than for example GSM communication. This means that even though the mobile device 100 need to continuously run a scanning process in order to search and identify any RFID tags 150 in nearby wireless networks the power required for this is less than the power required for GSM communication.

Referring now to FIGS. 2 to 5, the operation of a mobile device 100 in a system or network 300, 400, 500 is illustrated. A user of mobile device 100 enters a work place for the user, herein referred to as the office (see e.g. FIGS. 2 and 3. The office may be a building, a floor, a room or the like. The size may be related to the obtainable position accuracy, but even if there are different RFID tags 150 or base stations within the office they may collectively be defined in the profile as one position, i.e. the position of the office. After entering the office the user for example wants to forward all calls to the office phone or a voice mail or changing the current mode to silent mode for the mobile device, if in a meeting, manually or automatically, or any other desired or required phone mode.

The user initiates manually an application or an application launches automatically, as defined earlier by the user, which involves setting up of a connection to a RFID system, see FIGS. 2 to 5, when the mobile device 100 has received data from an adjacent RFID tag 150. The user may define application profiles associated with specific RFID tags and store them in the memory 160 for manual initiation or automatic launching in order to change or maintain the functionality of the mobile device when data from a nearby RFID tag is received. The initiation of the application preferably includes automatic launching of for example a silent mode or a forwarding call mode for the mobile device when entering a meeting room and connecting to a RFID meeting room tag, but may of course also include launching an application where a manual selection in a menu system or activation of an icon in a graphical user interface of mobile device 100 is done.

In FIG. 1 the mobile device 100 is illustrated as a mobile phone, which is the best mode known to date for implementation of the present invention. Although not outlined in detail, mobile device 100 may therefore include, in addition to the elements mentioned earlier, a touch-sensitive sheet provided on the display 160, a speaker and a microphone.

The position of the device 100 in relation to adjacent RFID tags 150 may be constantly checked and determined or determined following the selection of an application.

Each of the RFID tags 150 has an ID that may be associated with a desired function, event, measure etc by the user. RFID tags that have should have no active function, i.e. they are passive, must also be registered in the memory 160 so that no automatic function is initiated or that no question about a new manual tag registration is prompted for the user next time this tag gets in range of the mobile device 100.

The storing of specific RFID data associated with a certain RFID tag 150 may be done as parameters in a specified storage field, in a predefined type of file or in a small data base in the mobile device 100.

The position of the mobile device 100 is established by comparing the received data from the associated RFID tag 150 with the RFID tag data contained in memory 160 by means of the control unit 120 and the memory 160, a profile related to the stored RFID tag data containing settings for different application is automatically selected, if a match is found, or manually initiated by the user, if the new RFID tag data is unknown, i.e. not found in the stored data, as shown in FIGS. 3 to 5. In one embodiment, a user may initiate an application in an area related to a certain position, wherein the user needs to manually select an application client, or alternatively the application is initiated with a default setting automatically. The user may also be requested via the GUI (steps 304-310 in FIG. 3) to respond whether the settings for the application should be stored in a new profile related to the new position or the new RFID tag 150 in question, which is determined by means of received data. In one embodiment it should also be possible to override the automatic selection of settings and launching of application based on matching of received RFID tag data with stored RFID tag data. This may be obtained by displaying, upon selection of an application in the mobile device 100, a question to the user whether or not to use stored settings. Answer Yes launches the application client linked to the profile in question with the associated stored settings of the associated RFID tag 150 for control of the mobile device functionality (steps 305-312 in FIG. 3). Answer No opens a menu in which the different parameters for launching the application or not can be selected. Also after such a scenario, i.e. when manual setting is made in a position and for an application which are already linked to each other in an existing profile in memory 160, the existing profile may be amended. Each profile is preferably uniquely identified with the determined RFID tag, and in combination with a selected application the settings to be used for launching that application, either automatically or after a manual initiation, are prescribed in the profile. In case the user wants to store the settings of the application in a new profile, a text description of the profile may be inserted automatically or manually by the user via the GUI, as in FIG. 3. In another embodiment the application settings may be stored automatically when an application is used in a position never used before, i.e. when data from a new RFID tag is received and no match is found in the stored RFID tag data.

Settings used for a profile “Office” may for example be VoIP codecs for voice compression, hi and low fidelity settings, authentication procedures such as 802.1x, WPA, WEP, PSK, EAP or the like, voice mail, email clients and the like, e.g. by switching to a new SMTP to be able to send e-mails or similar functions or more complex functions.

An embodiment of how to control the functionality of the mobile device 100 is schematically illustrated in FIGS. 2 to 5. Here, each position is defined by the data from the RFID tag 150 located at that specific position. Each profile further relates to different settings for different applications, such as enabling, disabling or maintaining automatic streaming of data and/or set up of Internet communication by which for example special shop offers, restaurant menus, advertising, or even movies showing replays when watching sport in an arena or showing events from different angles in the arena, WLAN access, VoIP, Bluetooth communication and the like are enabled, disabled or maintained.

In a preferred embodiment, each combination of profile and application may also comprise information on prescribed client and security aspects, and these settings are preferably automatically configured by mobile device 100 based on the received data from the associated RFID tag 150, or chosen manually by the user. If the position of e.g. a phone 100 indicates that it is used at work, a VPN client may automatically try to access the WLAN network at the office and the call client dictated by the employer will automatically be launched when the user tries to make a call. However, if the associated RFID tag, i.e. the “Home” RFID tag, instead indicates that the mobile device 100 is at home, the Home profile will instead be employed. The Home profile may specify a standard profile by which the application for “ordinary” GSM calls is launched or if a WLAN network with Internet communication is present at home WEP (Wired Equivalent Privacy) may be used to access the Home WLAN access point, and a VoIP client may be specified to be launched when the user tries to make a call. The illustrated embodiments of FIGS. 2 to 5 may also use a profile called public or standard, which profile also may be defined as a default value. This profile is preferably used when an application is launched at a position corresponding to any RFID tag data not previously stored in the memory 160. When a user of mobile device 100 starts an application, e.g. a call, in the presence of a public hot spot, and where the RFID tag data received from the hot spot is not found in the memory, mobile device 100 will for example launch the GSM call client. It should be noted, though, that in order to set up a connection using a VoIP client a WLAN access procedure has to be performed first. For the illustrated embodiment, also the settings for the VPN client may be prescribed for the public profile. However, in another embodiment of the present invention, the setting up of a connection in a position not stored in memory 160 must be performed manually by the user (steps 306-310 in FIG. 3), and the automatic procedure is only performed for positions known in the memory.

FIG. 4 shows when a current RFID tag 150 gets out of range of the mobile device 100 (step 401). The identity of the “lost” RFID tag is sent to the control unit 120 (step 402), and the “lost” RFID tag ID is checked (compared with memory 160, step 403). Then, in step 404, it is checked whether an activity or no activity is associated with the “lost” RFID tag 150, and if there is an associated activity, a reversed activity is initiated and performed, either manually by the user or fully automatic, in step 405, whereby the mobile device 100 is set to a new mode, e.g. an idle mode as in step 406 or a silent mode etc. If no activity is associated with the “out of range” RFID tag, the mobile device maintains the current mode, e.g. an idle mode as in step 406, a forwarding call mode or a sound mode in contrast to silent mode.

In FIG. 5, a menu handling of the RFID tag 150 and its data is shown (step 501). Here, a menu is shown on the display 170 of the mobile device 100 with different RFID choices for the user to choose among in step 502, whereby chosen settings, connections etc may be performed in step 503. Then, the presence of any RFID tag in range and if the tag is affected by the chosen functionality are checked and if the answer is Yes, an activity or reversed activity is initiated and performed in the mobile device in step 505, while, if the answer is No, the mobile device maintains its current mode/functionality, e.g. an idle mode as in step 506 or any other chosen mobile device mode.

1. A system for RFID data communication, comprising:
a mobile device with a control unit that is operatively connected to a RFID reader, a memory for storing a plurality of RFID tag data, and a GSM/UMTS radio; and
at least one by the mobile device wirelessly connectable RFID tag, which control unit, depending on the RFID tag data, is adapted to change or maintain the functionality of the mobile device.

2. A system according to claim 1, wherein the control unit is configured to compare the received RFID tag data with RFID tag data stored in the memory, and to change or maintain the functionality of the mobile device in accordance with the received RFID tag data.

3. A system according to claim 2, wherein, if the received RFID tag data is new when compared with the stored RFID tag data, the control unit is configured to register the received RFID tag data in the memory, and to associate the received RFID tag data with an activation application, which changes the current functionality of the mobile device, or a non-activation application, which maintains the current functionality of the mobile device, and to store the received RFID tag data with the associated application in the memory.

4. A system according to claim 1, wherein the control unit is configured to detect if the RFID tag is out of range, and to compare the data of the out of range RFID tag with the stored RFID tag data, and to perform an activity that changes or maintains the current functionality of the mobile device in accordance with the data of the out of range RFID tag.

5. A system according to claim 4, wherein the control unit is configured to enable, disable or maintain a silent mode, a forwarding calls mode, an AGPS functionality mode or a data streaming mode for the mobile device in accordance with the associated RFID tag data.

6. A system according to claim 4, wherein the control unit is configured to enable, disable or maintain a mobile device mode where all calls are forwarded to a voice mail or an office or mobile phone in accordance with the associated RFID tag data.

7. A system according to claim 4, wherein the control unit is configured to enable, disable or maintain the AGPS functionality mobile device mode in accordance with the associated RFID tag data.

8. A system according to claim 4, wherein the control unit is configured to enable, disable or maintain the mobile device streaming mode in accordance with the associated RFID tag data.

9. A mobile phone, comprising a control unit that is operatively connected to a RFID reader, a memory, a display, and a GSM/UMTS radio.

10. A radio communication device for RFID data communication, comprising a RFID reader that is operatively connected to a mobile device.

11. A method for steering the functionality of a mobile device by using RFID data communication, comprising:
transmitting a radio signal to a RFID tag;
receiving a response signal comprising RFID tag data from the RFID tag; and
depending on the RFID tag data, performing an activity that changes or maintains the functionality of the mobile device.

12. A method according to claim 11, comprising comparing the received RFID tag data with the stored RFID tag data, and, performing an activity that changes or maintains the functionality of the mobile device in accordance with the received RFID tag data.

13. A method according to claim 12, comprising, if the received RFID tag data is new when compared with the stored RFID tag data,
registering the received RFID tag data;
associating the received RFID tag data with an activation application changing the current functionality of the mobile device or a non-activation application maintaining the current functionality of the mobile device; and
storing the received RFID tag data with the associated application.

14. A method according to claim 1, comprising:
detecting that the RFID tag is out of range;
comparing the data of the out of range RFID tag with the stored RFID tag data; and
performing an activity that changes or maintains the functionality of the mobile device in accordance therewith.

15. A method according to claim 14, comprising:
enabling, disabling or maintaining a silent mode, a forwarding calls mode, an AGPS functionality mode or a data streaming mode for the mobile device in accordance with the associated RFID tag data.

16. A method according to claim 15, comprising:
performing an activity by putting the mobile device into a mode where all calls are forwarded to a voice mail or an office or mobile phone, or vice versa in accordance with the associated RFID tag data.

17. A method according to claim 15, comprising:
performing an activity by putting the mobile device into a mode where the AGPS functionality is enabled or disabled in accordance with the associated RFID tag data.

18. A method according to claim 14, comprising:
performing an activity by putting the mobile device into a mode where streaming is started from an address distributed by the associated RFID tag, or vice versa in accordance with the associated RFID tag data.
